(19) United States
(12) Patent Application Publication
(10) Pub. No.: US 2016/0031081 A1
(43) Pub. Date: Feb. 4, 2016

(54) SYSTEMS AND METHODS FOR THE MODULAR CONFIGURATION OF ROBOTS

(71) Applicant: Brian David Johnson, Portland, OR (US)

(72) Inventor: Brian David Johnson, Portland, OR (US)

(21) Appl. No.: 14/815,484

(22) Filed: Jul. 31, 2015

Related U.S. Application Data
(60) Provisional application No. 62/032,336, filed on Aug. 1, 2014.
(60) Provisional application No. 62/046,269, filed on Sep. 5, 2014.

(51) Int. Cl. B25J 9/16

(52) U.S. Cl. CPC B25J 9/1656

(57) ABSTRACT

The present disclosure describes embodiments related to the configuration of one or more robot computing devices. Robot computing devices are configured to have personality characteristics and to have relational characteristics with respect to other agents (humans, other computing devices, and/or other robots). A robot personality profile is generated and imprinted on the robot computing device. Robot computing devices are updated through the use of one or more biometric security keys, including an owner's visual appearance and/or voice.

### CROSS-REFERENCE TO RELATED APPLICATIONS

This application is a non-provisional application claiming priority to and the benefit of U.S. Patent Application Ser. No. 62/032,336, filed on Aug. 1, 2014 and titled “SYSTEMS AND METHODS FOR APP-BASED ROBOTS,” and U.S. Patent Application Ser. No. 62/046,269, filed on Sep. 5, 2014 and titled “SYSTEMS AND METHODS FOR THE MODULAR CONFIGURATION OF ROBOTS,” the entirety of each application is expressly incorporated herein by this reference.

### BACKGROUND

1. Field of the Invention

This invention relates generally to the field of programming and customizing robots.

2. Background and Relevant Art

The field of robotics, and programming artificial intelligence and personalities for robots in particular, is one that is occupied primarily by those having advanced knowledge and experience, such as persons holding advanced degrees in electrical/computer engineering and/or computer science. While software suites (e.g., Robot Operating System (ROS), DARwIN-OP) exist for providing core robotic operating systems and libraries for controlling robot input and output hardware, the actual software routines for giving a robot vision, speech, intelligence, personality, and functional purpose are generally custom-coded by a relative few having advanced knowledge and experience in robotics. For example, programming a robot may require advanced knowledge in areas including programming languages, artificial intelligence, the underlying hardware and software systems of robot systems, speech recognition and synthesis, image and video processing, etc. With such a large barrier to entry, a consumer market for advanced consumer-customizable robots has thus far failed to develop despite great public interest in the area.

### BRIEF SUMMARY

The present disclosure describes systems and methods for configuring robot computing devices. In certain embodiments, a method for configuring a robot computing device includes generating a robot configuration for the robot computing device by generating one or more security keys, the one or more security keys including at least one owner key identifying an owner associated with the robot computing device; generating a robot personality profile for the robot computing device, the robot personality profile including at least one robot personality setting for imprinting on the robot computing device; and configuring the robot computing device according to the generated robot configuration by forming one or more network connections with the robot computing device; running diagnostics on the robot computing device to verify proper operation of the robot computer device; and imprinting the robot computing device with the robot configuration, including sending the one or more security keys and the robot personality profile to the robot computing device over the one or more network connections.

In certain embodiments, a method for configuring a robot computing device according to a biometric key includes forming one or more network connections with a non-robot computing device; receiving, over the one or more network connections, a robot configuration including one or more biometric owner keys identifying an owner of the robot computing device by owner visual appearance and/or owner voice, and the robot personality profile including at least one robot personality setting for imprinting on the robot computing device; imprinting the robot configuration on the robot computing device; receiving a verbal request from a user to alter the robot configuration; analyzing the verbal request by comparing the request to the at least one biometric owner key; verifying that the user is authorized to modify the robot computing device; and executing the request.

In certain embodiments, a method for relationally communicating a robot computing device with another robot computing device includes forming one or more network connections with a non-robot computing device; receiving, over the one or more network connections, a robot configuration including one or more security keys including at least one robot key identifying the robot computing device, a robot personality profile including at least one robot personality setting for imprinting on the robot computing device, and a robot family rank setting associating the robot computing device with a device family including at least one additional computing device or robot computing device, and enabling the robot computing device to determine a hierarchical position within the device family; imprinting the robot configuration on the robot computing device; identifying the at least one additional computing device or robot computing device as a member of the device family; and based on the family rank setting, communicating with the at least one additional computing device or robot computing device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of the present disclosure, a more particular description of the invention will be rendered by reference to specific embodiments thereof which are illustrated in the appended drawings. It is appreciated that these drawings depict only illustrated embodiments of the invention and are therefore not to be considered limiting of its scope. Embodiments of the invention will be described and explained with additional specificity and detail through the use of the accompanying drawings in which:

FIG. 1 illustrates an example computer architecture that facilitates configuration of one or more robot computing devices;

FIG. 2 illustrates a message flow for installing and using a build application;

FIG. 3 illustrates a message flow for a robot imprinting protocol;

FIG. 4 illustrates an example robot personality profile tool for developing a robot personality profile;

FIG. 5 illustrates a personality module for modulating robot activity so as to provide a robot computing device with the impression of personality;

FIG. 6 illustrates a family module for modulating robot activity relative to identified agents based on a relative ranking;

FIG. 7 illustrates a family ranking rules engine for determining a relative ranking of a robot computing device with respect to an identified agent;

FIG. 8 illustrates a security keys module for managing one or more security keys related to the robot or to other agents within the robot's family;

FIG. 9 illustrates an example process for updating a robot computing device based on analysis of one or more biometric keys;

FIG. 10 illustrates a flow chart of an example method for configuring a robot computing device;

FIG. 11 illustrates a flow chart of another example method for configuring a robot computing device; and

FIG. 12 illustrates a flow chart of an example method for relationally communicating with another computing device or robot computing device.

### DETAILED DESCRIPTION

The present disclosure describes embodiments related to the configuration of one or more robot computing devices (also referred to herein as robot(s) for simplicity). Certain embodiments of the present disclosure relate to configuring one or more robots to have personality characteristics and to have relational characteristics with respect to other agents (humans, other computing devices, and/or other robots). Certain embodiments relate to updating the configuration of one or more robots through the use of one or more biometric security keys (e.g., an owner's visual appearance and/or voice).

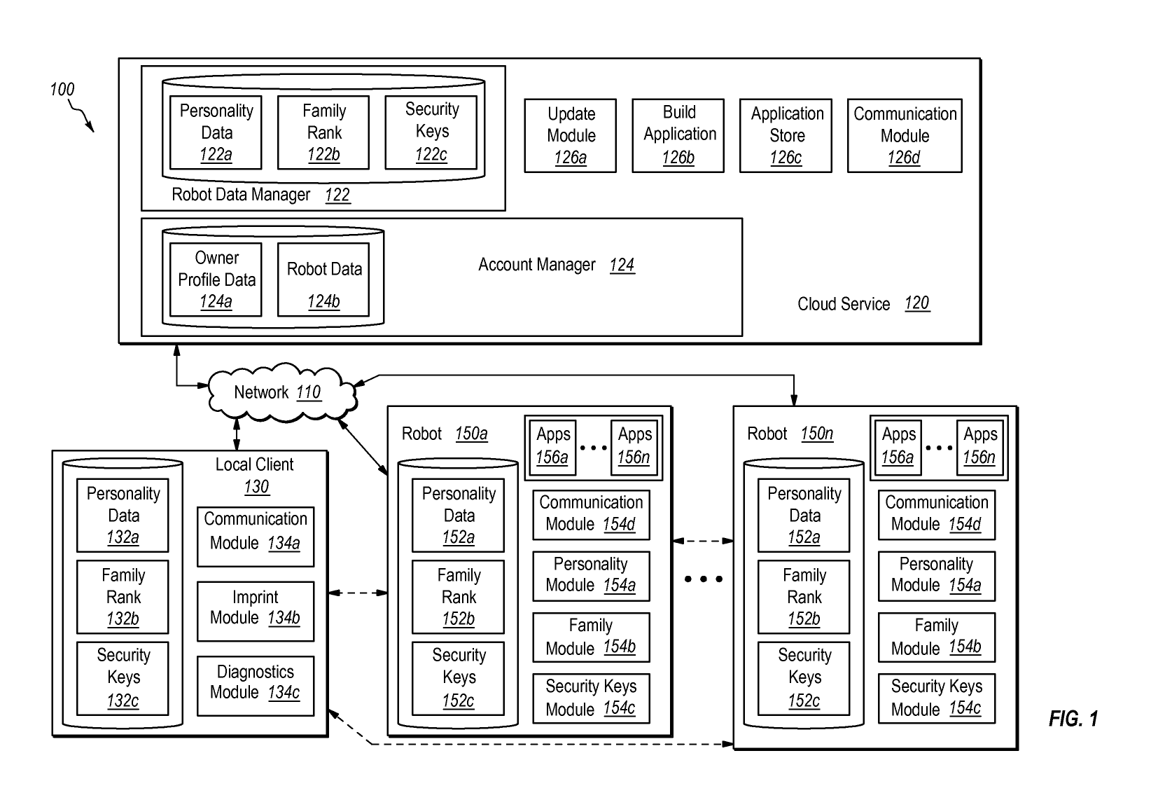

FIG. 1 illustrates one embodiment of an architecture 100 in which one or more robots may be configured, programmed, registered, managed, and/or customized. The illustrated embodiment includes a cloud service 120, a local client 130, and one or more robots 150a-150n. As indicated by the horizontal ellipses, architecture 100 can include any number of robots, and any reference herein to a single robot should be understood to refer to one or more robots. For example, a reference to robot 150 can refer to one or more robots 150a-150n.

As depicted by solid arrows in FIG. 1, the cloud service 120 and the local client 130 are typically located in physically different locations, and can be connected to one another through a network 110 (e.g., a Local Area Network (“LAN”), a Wide Area Network (“WAN”), and even the Internet). In addition, as depicted by solid arrows in FIG. 1, the cloud service 120 and the robot 150 may also be in physically different locations and connected to one another through the network 110. As depicted by dashed arrows in FIG. 1, the local client 130 and the robot 150 may be locally-connected, such as using a short-range wireless protocol (e.g., WiFi, Bluetooth, NFC, etc.) or a hardwired connection (e.g., serial, USB, thunderbolt, etc.).

The cloud-based service 120 can include a robot data manager 122 configured to manage, store, and/or communicate data related to one or more robots associated with a given account. For example, robot data manager 122 can be configured to receive and store robot data as it is generated at the cloud service 120 and/or local client 130 (e.g., during a robot design or build operation, or during a robot update operation). Robot data manager 122 can be configured to send robot data to the local client 130 and/or robot 150.

The robot data manager 122 can include storage containing robot personality data 122a, robot family rank data 122b, and security keys 122c. For example, robot personality data 122a can include personality and/or behavior data for one or more robots, robot family rank data 122b can include information hierarchically ranking robots within a group (or “family”) of robots, and security keys 122c can include owner identification information (“owner keys”) and/or robot identification information (“robot keys”).

In some embodiments, owner identification information can include biometric information related to an owner (e.g., visual appearance data such as facial data, voice data), and/or electronic information related to an owner's device (e.g., cryptographic keys stored at the local client 130, identifiers associated with owner controlled WiFi or Bluetooth signals, GPS locations). Similarly, in some embodiments, robot identification information can include robot visual and/or voice data, and in some embodiments, can include cryptographic keys, unique identifiers, or other electronic information stored at a robot device.

The cloud service 120 can also include an account manager 124 configured to manage a given account. For example, data sent or received by the cloud service 120 can be correlated with owner profile data 124a and/or robot data 124b stored at the cloud service 120 by the account manager 124. Owner profile data 124a can include information relating one or more owners to owned robots, account and/or payment information, activity logs, etc. Robot data 124b can include additional hardware and/or software information about one or more robots associated with a given account (e.g., information in addition to personality data, family rank, and security keys).

The cloud service 120 can also include an update module 126a configured to provide software updates to the local client 130 and/or robot 150. For example, the update module 126a can be configured to receive software status information from the local client 130 and/or robot 150 and compare the software status information with current software. In some embodiments, if it is determined that the local client 130 and/or robot 150 does not have the most current software and/or have requested the most current software, the update module 126a can send update data to the local client 130 and/or robot 150.

The cloud service 120 can also include a build application 126b configured to allow a robot to be designed, configured, and/or altered. The build application 126b can allow a user (e.g., a robot owner) to design and/or personalize a robot's physical appearance, personality, and family rank, for example. In some embodiments, the build application 126b can allow a user to select and/or manipulate certain physical components of a robot. For example, a user may be able to select, manipulate, and/or personalize one or more robot shell components (e.g., arms, legs, hands, feet, torso, head) configured to be attachable to a standardized robot skeleton base. In some embodiments, a user may be able to select and/or adjust personality components of a robot. For example, a user may be able to select and/or adjust a personality “score” of one or more personality traits (e.g., openness, conscientiousness, extraversion, agreeableness, neuroticism, etc.).

In some embodiments, the build application 126b can be presented to the local client 130 as a web application hosted by the cloud service 120. In other embodiments, a build application may be located at the local client 130 (e.g., as a program downloaded from the cloud service 120). In some embodiments, the cloud service 120 and local client 130 may work together to provide a build application. Some tasks and/or functions of the build application may be handled by the cloud service 120 and some may be handled by the local client 130, with tasks and/or functions divided based on relative processing power, for example.

In some embodiments, the build application 126b can be used to establish one or more user accounts for a user at the client device 130. For example, the build application 126b can present one or more user interfaces at the local client 130 for obtaining user information (e.g., name, user name, contact information, credentials, etc.), which can be stored in the owner profile data 124a at the cloud service 102. In another example, the build application 126b can present one or more user interfaces at the local client 130 for obtaining payment information (e.g., for purchasing robots, for purchasing robot applications, for subscription to a developer account), which can be stored in the owner profile data 124a at the cloud service 120.

In addition, the build application 126b can be used to activate and register the robot 150 to an owner account. The particular mechanism for initiating activation/registration of a robot may be varied. For example, the build application 126b may wirelessly detect any robots (or any non-activated robots) in the vicinity of the client device 130, initiate a wireless pairing with the robot 150, and then initiate activation/registration. In another example, the build application 126b can initiate activation/registration of a robot when a hard-wired connection is established between the client device 130 and a robot. In another example, the build application 126b can display a machine-readable code (e.g., QR Code) on a display device, which may be used by a robot to initiate activation/registration when viewed by a camera at the robot 150. In another example, a robot 150 may detect a local client 130 running the build application 126b on power-up or upon entry of a predefined sequence (e.g., movement of limbs, input from buttons, etc.), and initiate activation/registration.

Activation/registration can include the generation of one or more security keys for identifying the robot 150. These keys can be stored as one or more of the security keys 122c. For example, security keys generated during activation/registration of the robot 150 can include, for example, the name of the robot 150, an identifier associated with a WiFi and/or Bluetooth connection shared between the robot 150 and the local client 130.

In some embodiments, a “hello protocol” may be performed as part of activation/registration of the robot 150. The “hello protocol” may be conducted by the local client 130, by the robot 150, or through cooperation between the two. The “hello protocol” may include a variety of actions, such as providing the robot 150 a name, performing system diagnostics of the robot 150, performing system updates on the operating system of the robot 150, installing a default set of applications on the robot 150, etc. During the “hello protocol,” user interaction may occur through one or more user interfaces provided through the build application 126b, or through the robot 150 itself. For example, when interaction is through the robot 150, the robot 150 may audibly speak, “what is my name?” and a user may audibly respond with a desired name for the robot 150.

The cloud service 120 can also include a robot application store 126c configured to provide a library of applications available for installation on the robot 150. In some embodiments, the applications may be created by a developer community, including government organizations, educational organizations, businesses, individual users, etc. Applications may be created by experts and novices alike, and may be usable as modular components for configuring a robot for particular functionality, personality, etc.

Applications may conform to a set of developer guidelines, and may be programmed according to application programming interfaces (APIs) that are provided by the robot 150. For example, the robot 150 may include libraries and/or middleware associated with an operation system or operating environment (e.g., ROS, DARwIN-OP) on the robot 150 and any additional libraries and/or middleware that provide robot-related control, input, and/or data processing functionality. For example the libraries/middleware 108a may include computation system APIs (e.g., general computing APIs, speech APIs, vision processing APIs, etc.), motion APIs (e.g., frameworks for controlling motion of the robot), sensing APIs (e.g., frameworks for enabling access to sensors in the robot), and the like.

Applications may be installed on the robot 150 using the build application 126b by providing one or more user interfaces with which a user can search/browse applications that are available at the cloud service 120. Once a desired application (or applications) is found, the build application 126b can download it (or them) to the client device 130.

In some embodiments, the local client 130 can send the application(s), to the robot 150. For example, a transfer of an application from the local client 150 to the robot 150 may be conducted by pushing the application(s) to the robot 150 through a local connection such as WiFi, Bluetooth, USB, etc.

The cloud service 120 can also include a communication module 126d that provides application programming interfaces (APIs) that enable the local client 130 and the robot 150 to communicate and share data with the cloud service 120 (e.g., through communication modules 134a and 154d, respectively).

The local client 130 can be a programmable computer, such as desktop computer, laptop computer, tablet computer, smartphone, etc. The local client 130 can include storage containing robot personality data 132a, robot family rank data 132b, and security keys 132c. For example, the local client 130 can receive the robot personality data 132a, robot family rank data 132b, and security keys 132c from the robot personality data 122a, robot family rank data 122b, and security keys 122c of the cloud service 120 and vice versa, such that the data associated with the robot data manager 122 is synchronized between the cloud service 120 and the local client 130. In some embodiments, a change or update to such data on either the cloud service 120 or the local client 130 can be sent (e.g., pushed or pulled) to the other in order to maintain synchronization.

The local client 130 can include an imprint module 134b configured to send the robot personality data 132a, robot family rank data 132b, and/or security keys 132c to the robot 150 in order to imprint the robot 150 (e.g., during a “hello protocol” operation). The local client 130 can also include a diagnostics module 134c configured to enable hardware and/or software diagnostics of the robot 150, such as during initial activation/registration of the robot 150 (e.g., during a “hello protocol” operation). In some embodiments, the functions of the imprint module 134b and/or diagnostics module 134c can be performed within the build application 126b. In other embodiments, the imprint module 134b and/or diagnostics module 134c can function independent of the build application 126b.

The robot 150 can be any device having movable components and that is configured to be programmable using applications originating from the cloud service 120 or that are locally-created (e.g., at the local client 130). Accordingly, the robot 150 can include programmable computer hardware and computer communications devices (e.g., wireless communications devices and/or hard-wired communications devices). In some embodiments, the robot 150 will include one or more input or sensory devices (e.g., selected from cameras, light sensors, motion sensors, switches, pressure sensors, microphones, heat sensors, gas sensors/detectors, and the like), one or more output devices (e.g., selected from speakers, displays, lights and/or LEDs, and the like), and one or more motion devices (e.g., motors, servos, actuators, etc.).

The robot 150 can include storage containing personality data 152a, family rank data 152b, and security keys 152c. The robot 150 can receive personality data 152a, family rank data 152b, and/or security keys 152c from the cloud service 120 and/or the local client 130. For example, data associated with the robot data manager 122 may be synchronized across the cloud service 120, local client 130, and robot 150. In some embodiments, a change or update to such data at the cloud service 120, the local client 130, or the robot 150 can be sent (e.g., pushed or pulled) to the other locations in order to maintain synchronization.

The robot 150 can also include a personality module 154a configured to translate the personality data 152a into a list of behaviors. As described in more detail below, the personality module 154a may convert one or more personality settings as established by an owner (e.g., using the build application 126b) and stored in the personality data 152a (and/or 122a and/or 132a) into a collection of behaviors that can collectively correspond to an overall personality profile of the robot 150.

The robot 150 can also include a family module 154b configured to translate the family rank data 152b into an action filter that can modulate the activity of the robot 150. As described in more detail below, the family module 154b may convert a family rank setting as established by an owner (e.g., using the build application 126b) and stored in family rank data 152b (and/or 122b and/or 132b) into an action filter that can adjust one or more behaviors of the robot 150, including adjusting one or more of the generated behaviors output from the personality module 154a and/or adjusting a relationship between one or more of the generated behaviors.

The robot 150 can also include a security keys module 154c configured to exchange and/or analyze one or more security keys 152c with the local client 130, cloud service 120, and/or one or more additional robots. As explained in more detail below, the security keys module 154c can enable the robot 150 to exchange and/or analyze security keys 152c (and/or 122c and/or 132c) related to the robot, such as a robot visual appearance key or a robot voice key, keys related to an owner, such as an owner visual appearance key or an owner voice key, and/or keys related to another robot, such as robot visual appearance keys or robot voice keys relating to one or more other robots within the same robot “family.”

The robot 150 can also include one or more applications 156a-156n (referred to hereafter as application(s) 156 for simplicity). One or more of the application(s) 156 may be downloaded from the application store 126c (e.g., either directly to the robot 150 or through the local client 130). The application(s) 156 can be configured to adjust one or more behaviors of the robot 150, including adjusting one or more of the generated behaviors output from the personality module 154a and/or adjusting a relationship between one or more of the generated behaviors.

For example, a robot may be configured as an advanced alarm clock using an alarm clock application that may be used in conjunction with one or more additional applications. In one example configuration, the alarm clock application may be used in conjunction with a speech synthesis application and a dancing application, such that when an alarm goes off the robot sings and dances. In another example configuration, the alarm clock application may be used in conjunction with the security keys module 154c, such that when an alarm goes off the robot 150 follows a recognized user (e.g., an owner recognized according to an owner visual appearance key) around. In another example configuration, the alarm clock application may be used in conjunction with the family module 154b and the security keys module 154c, such that when an alarm goes off the robot 150 finds other robots and/or devices that are part of the family (e.g., recognizing them via security keys such as digital security keys and/or visual appearance security keys) and informs the other robots and/or devices to sound an alarm. In another example, the alarm clock application may be used in conjunction with the personality module 154a, such that when an alarm goes off the robot 150 sounds an alarm according to one or more personality settings. For example, a more aggressive robot may loudly announce that the alarm has gone off, while a more timid robot may quietly announce the alarm.

In some embodiments, the application(s) 156 may be used in conjunction with one or more additional applications, the personality module 154a, the family module 154b, and/or the security keys module 154c. Using the example of the alarm clock application again, the robot 150 may be configured such that when an alarm goes off the robot announces the alarm in a manner consistent with a personality setting (by working in conjunction with the personality module 154a) while simultaneously looking for other devices and/or robots within the family (by working in conjunction with the family module 154b and the security keys module 154c), and while singing and/or dancing (by working in conjunction with one or more additional application(s) 156).

The system architecture 100 depicted in FIG. 1 illustrates one exemplary embodiment of the present disclosure. One of skill in the art will recognize that the depicted modules and/or storage components may be presented in other configurations without impairing the intended functionality of the system. For example, robot personality data 122a, family rank data 122b, and/or security keys 122c may be stored at the cloud service 120, at the local client 130, at the robot 150, or at all three locations or some combination of such locations. In another example, the functions of the build application 126b or a portion thereof may be performed by one or more additional applications of the cloud service 120 or the local client 130.

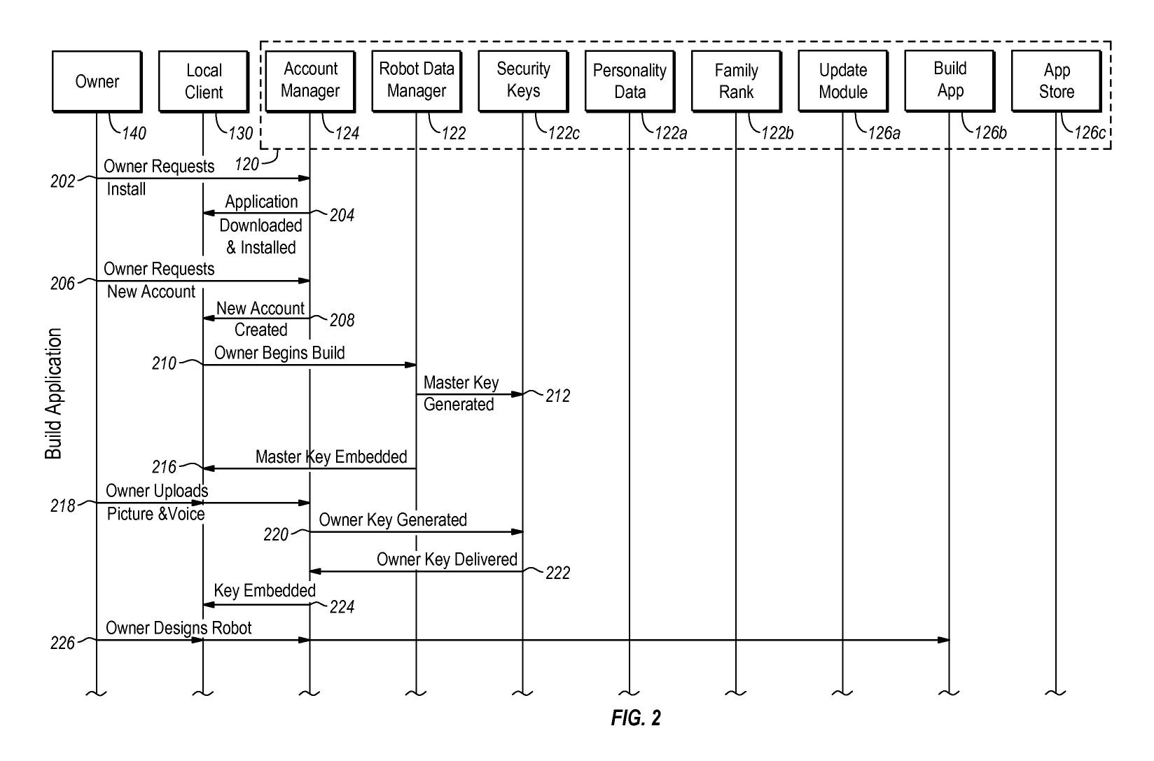

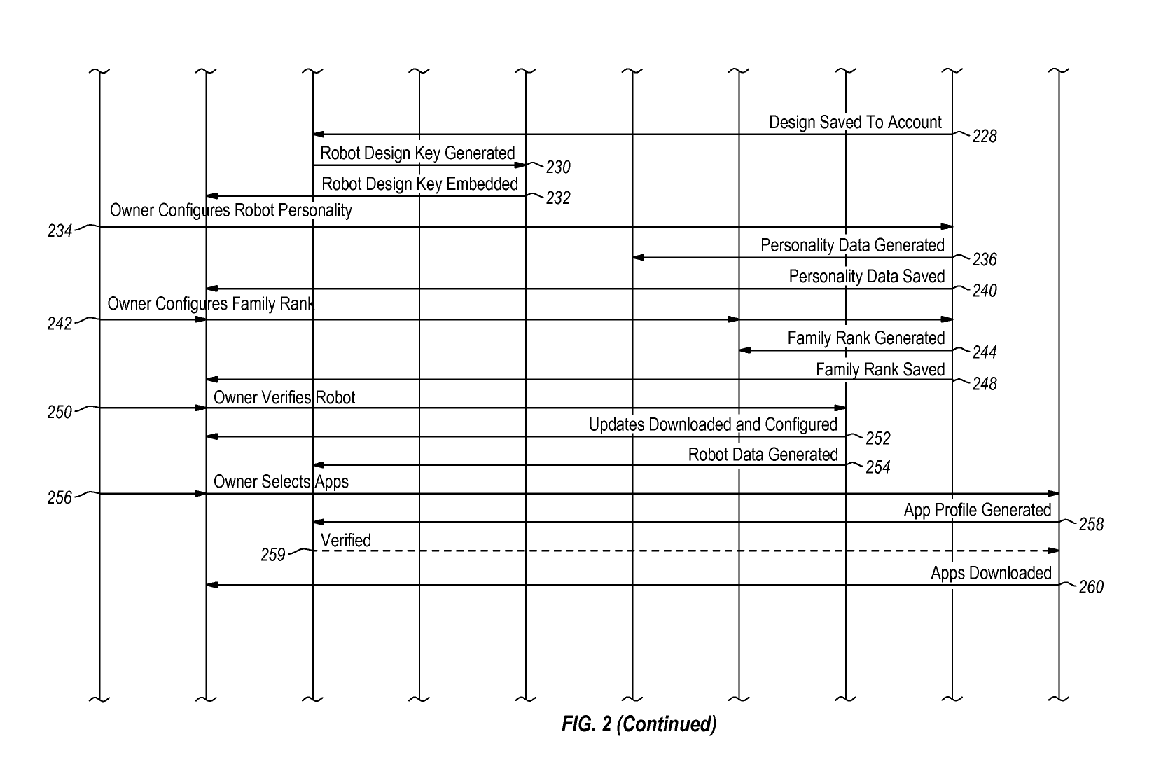

FIG. 2 illustrates an embodiment of a build procedure. In the illustrated embodiment, the build procedure can include installing and using the build application 126b on the local client 130. FIG. 2 illustrates at 202 that an owner 140 can request (via local client 130) an install of the build application. At 204, the cloud service 120 (e.g., via the account manager 124) can send the application to the local client 130 to be downloaded and installed. At 206, the owner 140 can request, via local client 130, a new account, and at 208, the account manager 124 can create the account and send notification to the local client 130. At 210, the local client 130 can send an instruction to begin the build. At 212, the robot data manager 122 of the cloud service 120 can generate a master key and store it at security keys 122c, and can send the master key to the local client 130 at 216.

As illustrated at 218, the owner 140 may upload owner picture and voice data to the local client 130 and/or account manager 124, and at 220, one or more owner keys may be generated and stored at security keys 122c. At 224, the one or more owner keys may be delivered to the local client 130. As illustrated at 226, the owner may design a robot by sending design instructions to the build application 126b (e.g., via local client 130), and at 228, the build application 126b can send and/or save a robot design with the account manager 124. At 230, the account manager 124 can generate one or more robot design keys (e.g., based on the received robot design such as a visual appearance key, voice key, and/or digital key) and save it/them at security keys 122c. At 232, the one or more robot design keys can be sent to the local client 130.

As illustrated at 234, the owner 140 may configure a robot personality by sending one or more personality settings (e.g., to create a personality score/profile) to the cloud service 120 using the build application 126b. At 236, personality data can be generated by the build application 126b and stored at personality data 122a, and at 240, the personality data can be sent to the local client 130. As illustrated at 242, the owner 140 may configure a robot family rank by sending one or more family rank settings to the cloud service 120 using the build application 126b. At 244, family rank data can be generated by the build application 126b and stored at family rank data 124b, and at 248, the family rank data can be sent to the local client 130.

As illustrated at 250, the owner 140 can send a verification to the update module 126a. The verification can, for example, include hardware information, software information, one or more unique identifiers, purchase codes, receipt information, or other information verifying that a given robot has been legitimately purchased. At 252, the update module 126a can verify the robot as legitimately purchased and can send updates to the local client 130, where they may be downloaded and configured. At 254, the update module 126a can send robot data (e.g., including information related to robot hardware, software, most recent updates purchased by owner and/or sent to owner) to the account manager 124.

As illustrated at 256, an owner 140 can send an application selection to the application store 126c. At 258, an application profile can be generated (or updated for return users) and sent to the account manager 124. At 259, the account manager 124 can verify the application profile (e.g., by comparing it to user profile data such as purchase data and/or account data) and can send verification to the application store 126c. At 260, the applications can be sent to the local client 130.

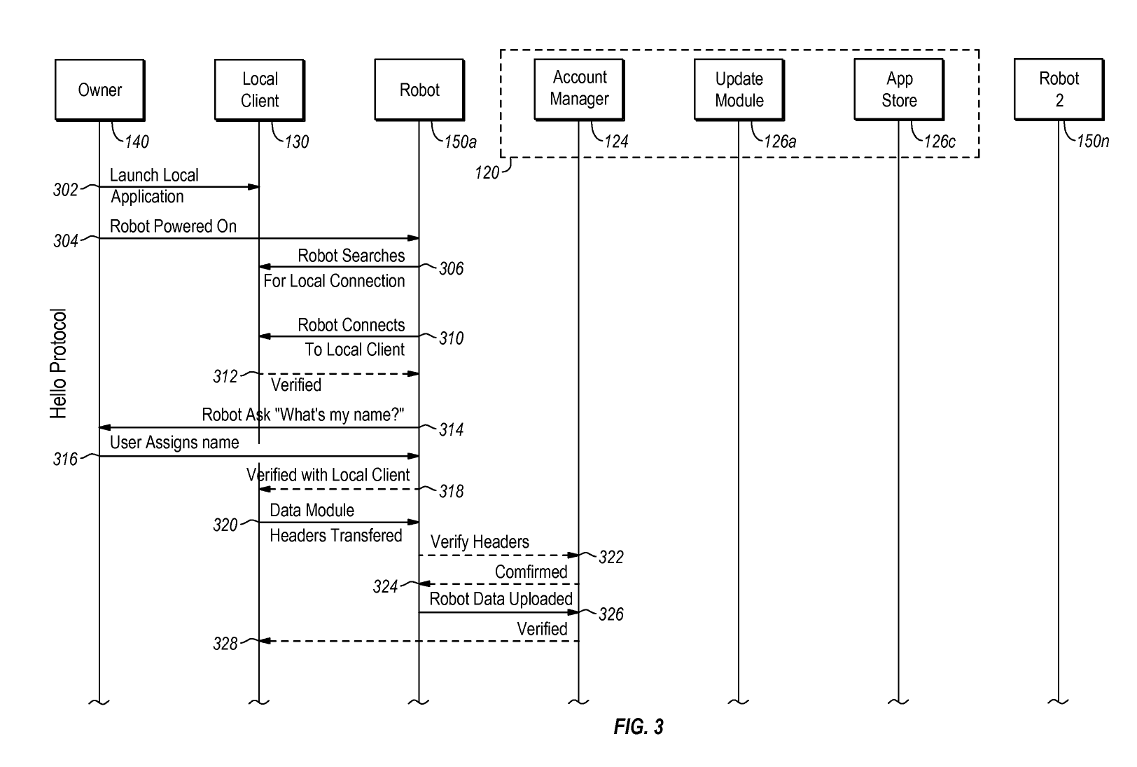

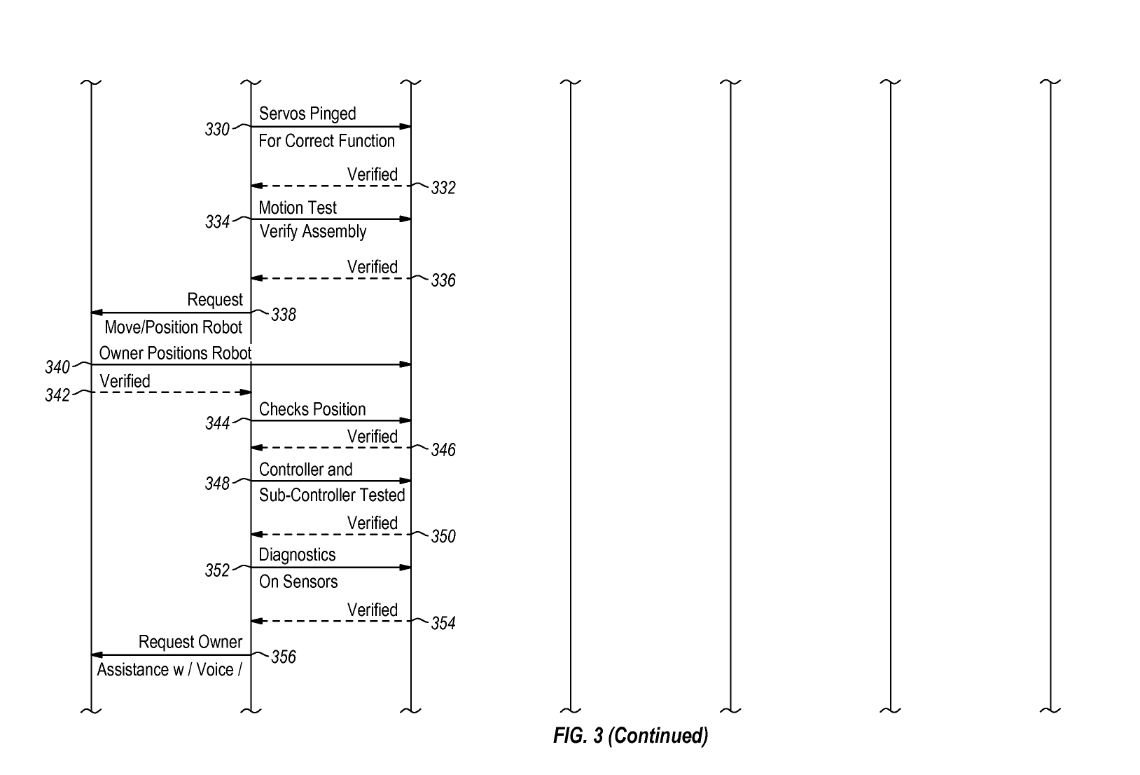

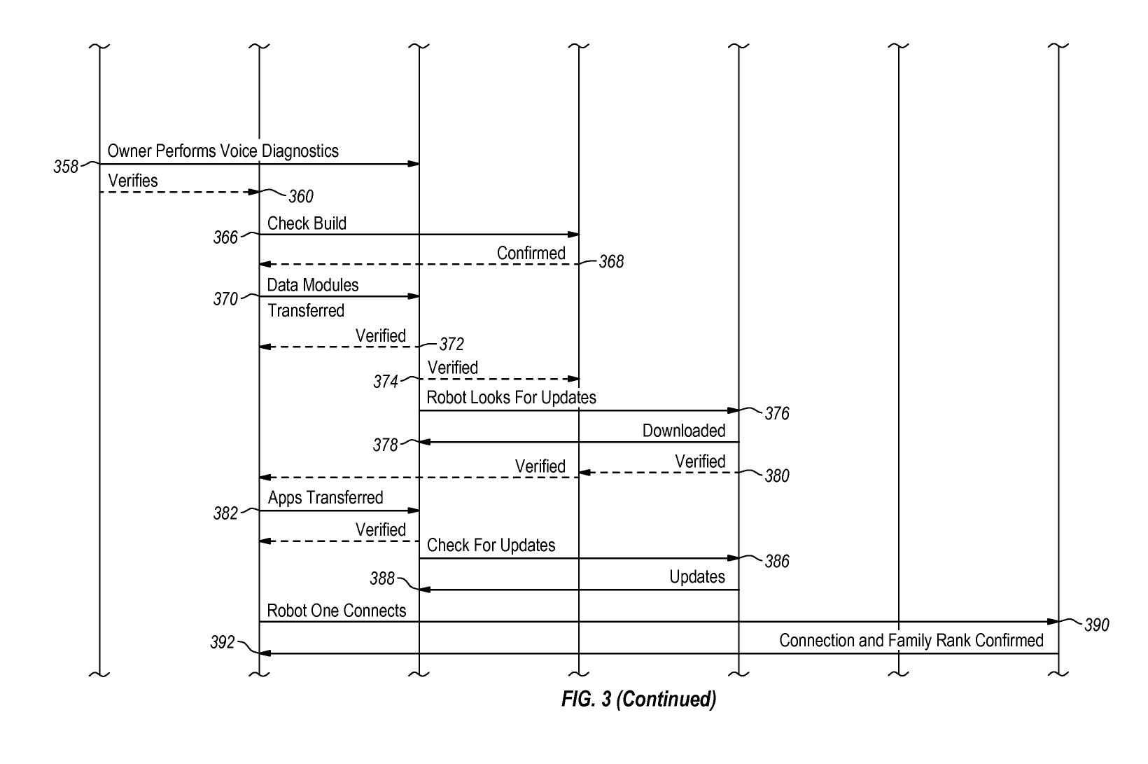

FIG. 3 illustrates an embodiment of imprinting a robot using a “hello protocol.” As illustrated at 302, the owner 140 can launch a local application at the local client 130, and at 304, can power on the robot 150a. At 306, the robot 150a can search for a local connection, which can be, for example, a short-range wireless connection (e.g., WiFi, Bluetooth, NFC, etc.) or a hardwired connection (e.g., serial, USB, thunderbolt, etc.). At 310, the robot 150a can connect to the local client 130 via the local connection, and at 312, the local client 130 can verify the connection.

As illustrated at 314, the robot 150a can request a name, such as by verbally asking “what's my name?” At 316, the user assigns a name to the robot 150a. In some embodiments, this may be accomplished by verbally speaking the name, and the robot 150a sensing the audio and determining the name from the received audio signal. In other embodiments, the name may be assigned through the local client 130 and transferred to the robot 150a via the local connection. At 318, the robot 150a can verify the assigned name with the local client 130.

As illustrated at 320, the local client 130 can transfer data module headers to the robot 150a. The data module headers can include information related to personality data, family rank data, security keys, applications, and/or other information generated using the build application (e.g., using the embodiment described in FIG. 2). The data module headers can provide the robot 150a with an outline of such data and/or can direct the robot 150a where to store such information once it is received. At 322, the robot 150a can verify the data module headers with the cloud service 120. At 324, the account manager 124 of the cloud service 120 can compare the received data module headers and compare them to the relevant information stored at the cloud service 120 to ensure that the data module headers sent by the local client 130 are synchronous with the data stored at the cloud service 120 and can send confirmation to the robot 150a.

As illustrated at 326, the robot 150a can send robot data (e.g., hardware information, software information, and/or other build information) to the account manager 124. At 328, the account manager 124 can compare the received robot data to the relevant records of the cloud service 120 and can send verification to the local client 130.

In some embodiments, the local client 130 and/or cloud service 120 can engage in diagnostic of the robot 150a by testing one or more hardware or software components. For example, as illustrated at 330, the local client 130 can ping one or more servos of the robot for correct function. At 332, the robot can test the one or more servos and send verification to the local client. At 334, the local client can send one or more motion tests (e.g., test motion instructions) to verify the assembly of the robot 150a, and at 336 the robot can send verification to the local client 130.

As illustrated at 338, for some diagnostics procedures, the local client 130 may request that the owner 140 move or position the robot 150a. At 340, the owner 140 can position the robot, and can verify to the local client 130 that the robot 150a has been positioned. At 344, the local client 130 can check the position of the robot 150a, and at 346, the robot 150a can send verification to the local client 130. At 348, the local client 130 can send one or more controller and/or sub-controller test instructions to the robot 150a, and at 350, the robot 150a can send verification to the local client 130. At 352, the local client 130 can send one or more sensor test instructions, and at 354, the robot 150a can send verification to the local client 130.

As illustrated at 356, the local client may request that the owner 140 assist with robot voice diagnostics. At 358, the owner 140 may perform voice diagnostics on the robot 150a, such as by listening to the robot speak one or more words or phrases, checking volume levels, making adjustments to voice parameters such as pitch, talking speed, volume, etc. At 360, the owner 140 can verify the voice diagnostics at the local client 130. As illustrated at 366, the local client 130 can check the build of the robot 150a by sending robot data to the account manager 124. At 368, the account manager 124 can compare the information received from the local client 130 with robot data stored at the cloud service 120, and can send verification that the robot build is correct to the local client 130.

As illustrated at 370, the local client 130 can imprint the robot 150a by transferring the data modules to the robot 150a. The data modules can include personality data, family rank data, and/or security keys generated during a build procedure (such as the build procedure illustrated by FIG. 2). At 372, the robot 150a can send verification to the local client 130, and at 374, the robot can send verification to the account manager 124. As illustrated at 376, the robot 150a can check the cloud service 120 (e.g., by checking the update module 126a) for updates. At 378, the updates (if any) can be downloaded at the robot 150a. At 380, the update module 126a can send verification to the account manager 124 and to the local client 130.

As illustrated at 382, the local client can transfer one or more applications to the robot 150a, and at 384, the robot can send verification to the local client 130. At 386, the robot 150a can check the cloud service 120 (e.g., by checking the application store 126c) for updates. At 388, the updates (if any) can be downloaded at the robot 150a. In some embodiments, the robot 150a can be linked to one or more additional robots and/or to one or more non-robot computing devices as a member of a robot and/or device “family.” For example, as illustrated at 390, the local client 130 can mediate the linking of the robot 150a to a second robot 150n. At 392, the connection and family rank of robot 150a relative to robot 150n can be confirmed. In other embodiments, the robot 150a and the robot 150n may be linked without using the local client 130 to mediate the connection. For example, in some embodiments, the robot 150a and/or the robot 150n may use one or more security keys to recognize the visual appearance and/or voice of the other robot, thereby recognizing the other robot as belonging to the robot family and using family rank data to recognize the family rank with respect to the other robot.

In some embodiments, other, non-robot computing devices may also be configured as members of a robot family. For example, a robot may be configured so as to recognize an owner's computer, laptop, router, mobile telephone, tablet and the like according to one or more digital security keys and/or other unique identifiers. In one example, a robot may be configured to recognize an owner's computing device by connecting to the same local network (e.g., the same WiFi network). In another example, a home gateway security computing device may act as an “older sibling” to a robot, and may provide instructions to the robot, such as an instruction to examine a noise detected in the garage.

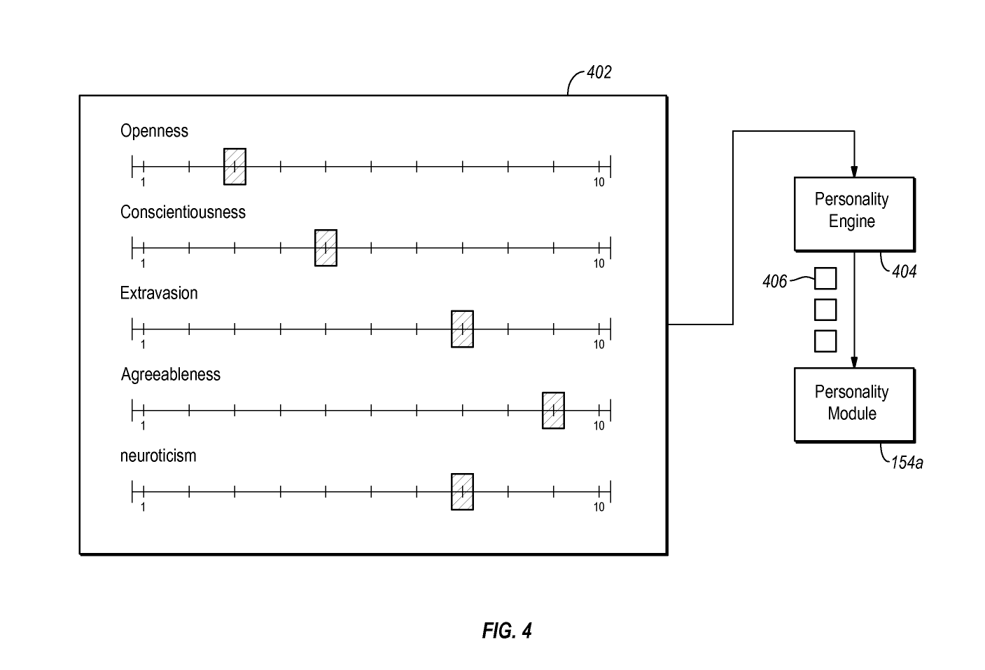

FIG. 4 illustrates an embodiment of a personality profile tool 402 that may be used in a build protocol (e.g., using the build application 126b). The personality profile tool 402 may be presented to an owner at a computer-generated user interface (e.g., at a user interface at the local client 130). As illustrated, the personality profile tool 402 can include one or more user-selectable objects enabling a user to select a personality setting. In the illustrated embodiment, the user-selectable objects can include sliders allowing a user to select the level of openness, conscientiousness, extraversion, agreeableness, and neuroticism of a robot personality. In other embodiments, a personality profile tool may be configured with other user-selectable objects and/or other personality elements, such as dials, scales, number entry, prompts, or other means for allowing user selection.

The personality profile tool 402 can be configured to compute a personality profile according to the personality settings selected by a user. For example, the personality settings selected by a user using the personality profile tool 402 can be sent to a personality engine 404 (which can located at the local client 130, the cloud service 120, the robot 150, or some combination thereof). The personality engine 404 can use the received data to generate one or more robot behaviors 406 which can be to the personality module 154a. For example, in some embodiments, the personality engine 404 can compile the received personality settings into a personality “score.” The personality score can be correlated to a personality table having a list of behaviors for different personality scores. The behaviors may define how the robot responds in various situations (e.g., how close the robot allows a human to get to it before recognizing the person or moving to avoid the person, what set of voice prompts to use, how quickly to perform movement, how coordinated the robot's movement is, the style of the robot's walk, how often the robot speaks, how loud the robot speaks, how obedient the robot is, etc.) to create the impression of personality.

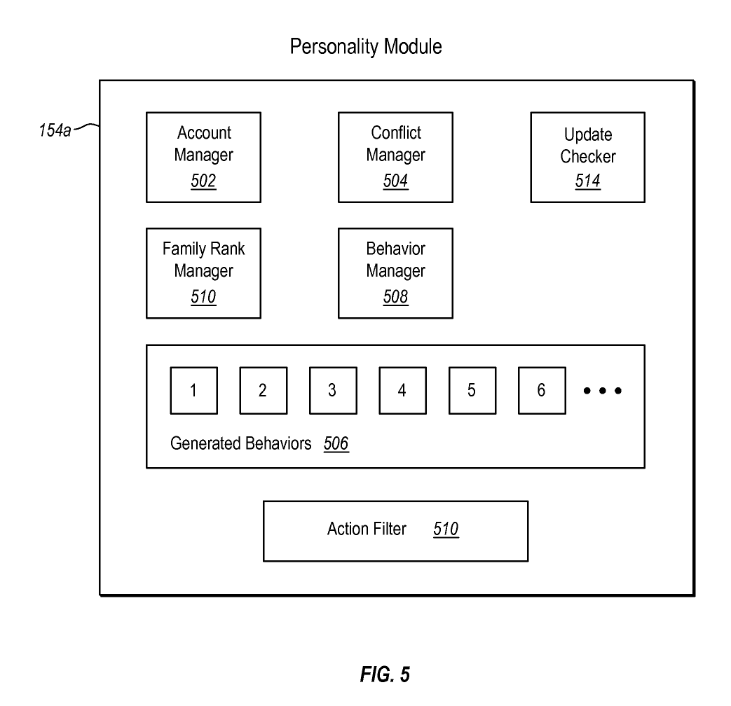

FIG. 5 illustrates an embodiment of the personality module 154a in greater detail. As illustrated, the personality module 154a can include a list of generated behaviors 506 (e.g., the generated behaviors 406 received from the personality engine 404 as illustrated in FIG. 4). The personality module 154a can include an account manager 502 configured to communicate with the cloud service 120 to send and receive owner profile data, robot data, security settings, account information, etc. The personality module 154a can include an update checker 514 configured to check (e.g., automatically or upon instruction) for updates to personality data (e.g., from the cloud service 120 and/or local client 130).

The personality module 154a can include a family rank manager 510 configured to coordinate modifications to the generated behaviors 506 based on family rank data of the robot. For example, one or more generated behaviors that give the robot an aggressive personality may be turned off or adjusted to be less aggressive-like when the robot is in the vicinity of an “older sibling” robot.

The personality data module 154a can also include a behavior manager 508 configured to coordinate the operation of the generated behaviors 506. For example, the behavior manager 508 may be configured to direct the timing and/or frequency of execution of certain generated behaviors. For example some behaviors may be directed to occur randomly (e.g., shifting feet, folding arms, looking around room), and some behaviors may be directed to occur or to occur more frequently in response to certain stimuli (e.g., waving, walking, and/or talking more in response to detecting greater movement and/or talking of humans or other robots), or in response to a lack of certain stimuli (e.g., yawning or sighing in response to a lack of interaction).

The personality data module 154a can also include a conflict manager 504 configured to enable the generated behaviors and/or applications to operate cooperatively to accomplish a task or to provide an overall robot configuration. For example, the conflict manager 504 can provide ranking rules that govern the execution of certain behaviors when they conflict with other behaviors and/or applications downloaded on the robot. For example, the conflict manager 504 can direct an alarm clock application to override any ongoing behaviors (e.g., talking, walking, etc.) in order to sound an alarm. In another example, a robot may have a “frightened of loud noises” behavior that directs a robot to monitor a volume meter, and if the volume meter surpasses a threshold volume, to detect the source of the sound (e.g., as directed by the behavior manager 508). The robot may then interrupt all other actions (e.g., as directed by the conflict manager 504) to move in a direction opposite the sound until the volume meter falls below the threshold level.

The personality data module 154a can also include an action filter 512 configured to coordinate behavior modifications generated by the family rank manager 510, conflict manager 504, and/or behavior manager 508 as they are applied to the generated behaviors 506. The generated behaviors 506 (as well as applications downloaded to the robot computing system) can be located at different locations within a robot computing device's data hierarchy. For example, some behaviors may reside at a relatively high level above the robot computing device's operating system, and some may provide direct control over servos and/or sensors by bypassing the operating system. Where the generated behaviors and applications reside can be determined by the conflict manager 504, behavior manager 508, and/or family rank manager 510.

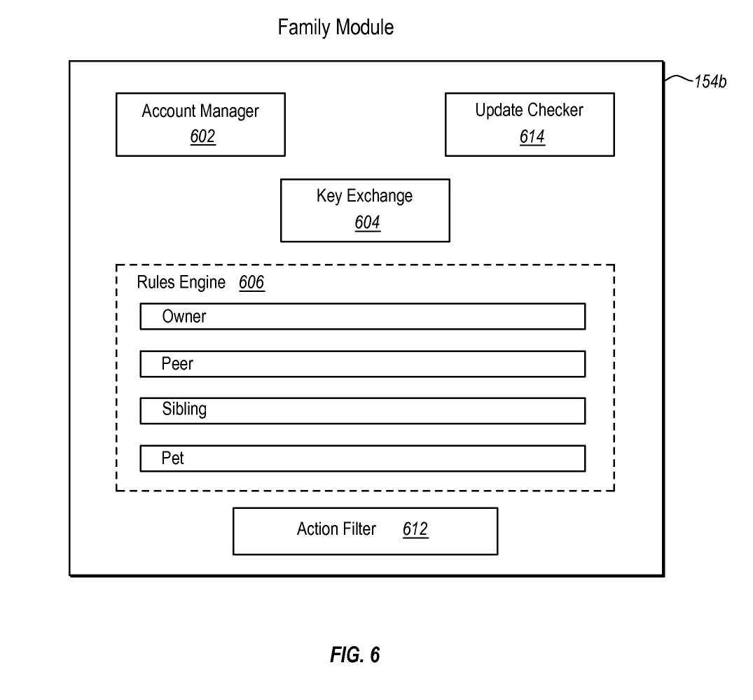

FIG. 6 illustrates an embodiment of the family module 154b. As illustrated, the family module 154b can include an account manager 602 and an update checker 614, which may be configured similar to the account manager 502 and update checker 514 illustrated in FIG. 5. The family module 154b can also include a key exchange 604 configured to coordinate with the security keys module 154c in order to identify an agent (human, other robot, or other computing device) as a family member. The family module 154b can also include a rules engine 606 configured to determine the relationship of the robot with respect to the identified agent and an action filter 612 configured to coordinate modifications to robot behavior based on output from the rules engine 606 (e.g., by directing the information to the action filter 512 and/or family rank manager 510 of the personality module 154a).

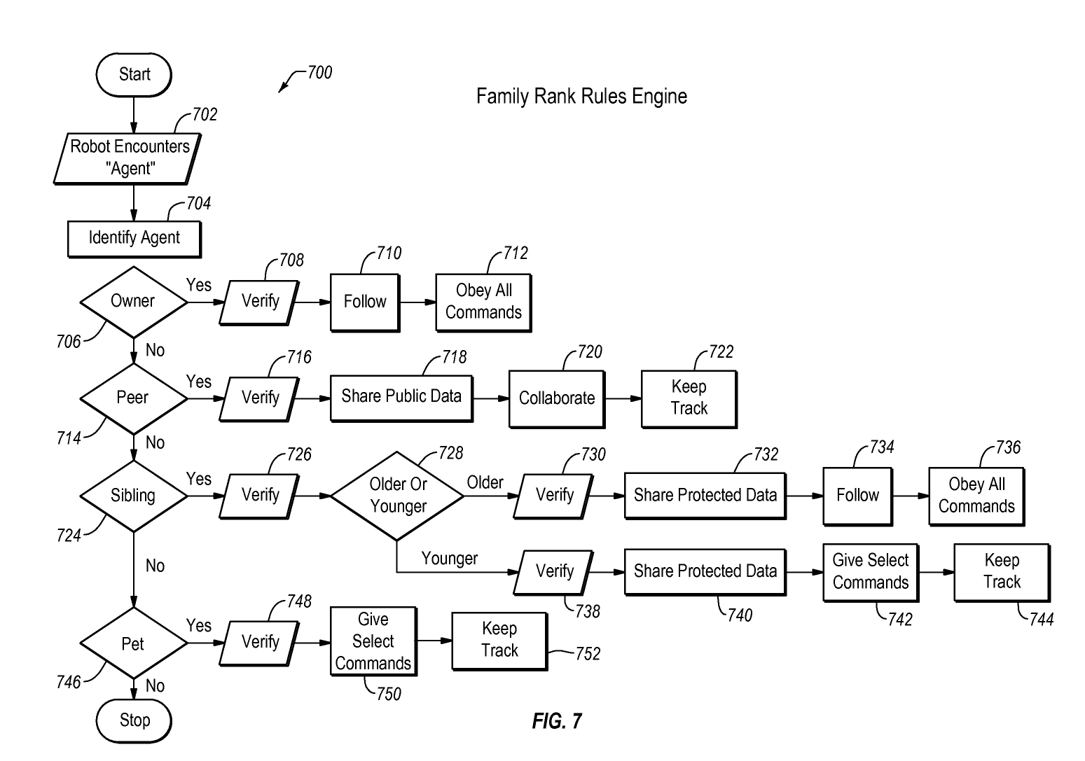

FIG. 7 illustrates an embodiment of the rules engine 606 of FIG. 6 in greater detail. The rules engine can perform a process 700 wherein a robot encounters an agent at 702. The robot can identify the agent at 704 (e.g., according to key exchange 604 illustrated in FIG. 6). At 706, the robot can determine if the identified agent is the robot's owner. If yes, the robot can verify at 708, follow the owner at 710, and obey all commands of the owner at 712. If no, the robot can determine if the identified agent is a peer (e.g., another robot or computing device that does not belong to the same family) at 714. If yes, the robot can verify at 716, share public data (e.g., non-secured activity logs, etc.) at 718, can collaborate with the peer at 720 (e.g., by performing a common task in tandem such as shaking hands, dancing together, etc.), and can keep track of the peer at 722. If no, the robot can determine whether the identified agent is a sibling at 724. If yes, the robot can verify at 726, and can determine whether the sibling is older of younger at 728. If older, the robot can verify at 730, can share protected data (e.g., applications, secured activity logs, etc.) at 732, can follow the older sibling at 734, and can obey select commands at 736. If the identified sibling is younger, the robot can verify at 738, share protected data at 740, can give select commands to the younger sibling at 742, and can keep track of the younger sibling at 744. If the identified agent is not a sibling, the robot can determine if whether the identified agent is a pet at 746. If yes, the robot can verify at 748, can give select commands to the pet at 750, and can keep track of the pet at 752. If no, the process can be stopped.

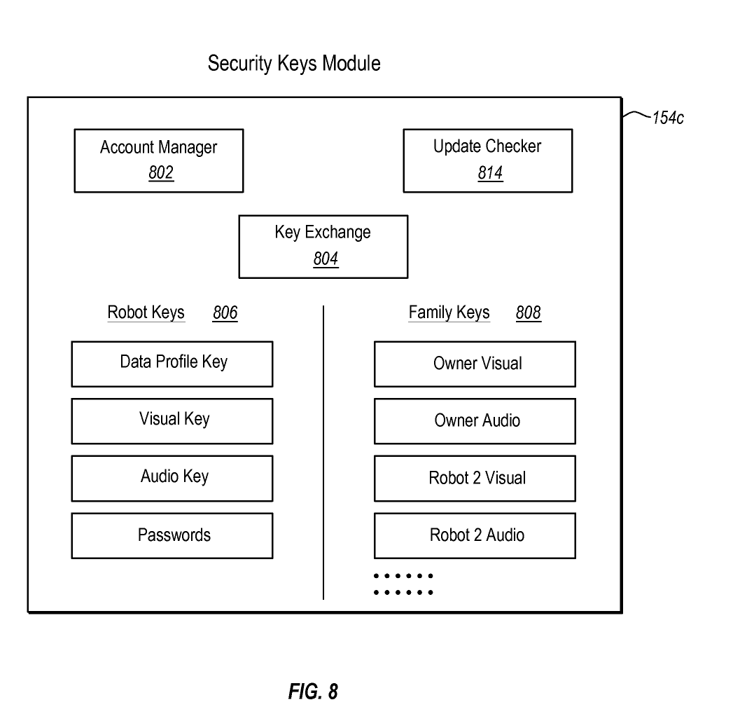

FIG. 8 illustrates an embodiment of the security keys module 154c. As illustrated, the security keys module 154c can include an account manager 802 and an update checker 804, which can be configured similarly to account manager 502 and 602 and update checker 504 and 604, respectively. The security keys module 154c can also include a key manager 804 configured to communicate security key information with other modules (e.g., key exchange 604 illustrated in FIG. 6). The security keys module 154c can include one or more robot keys 806 related to the robot, such as a data profile key (e.g., a key/password associated with the cloud service, the build application, and/or the owner's account), visual keys (e.g., a robot visual appearance key), an audio key (e.g., a robot voice key), and additional passwords (e.g., passwords enabling the robot to access third party services through one or more installed applications). The security keys module 154c can include one or more family keys 808 related to other robots, devices, or humans associated with the robot as family members, such as an owner visual appearance key, an owner audio/voice key, a second robot visual appearance key, a second robot audio/voice key, or keys associated with additional humans, robots, or devices (as indicated by the ellipses).

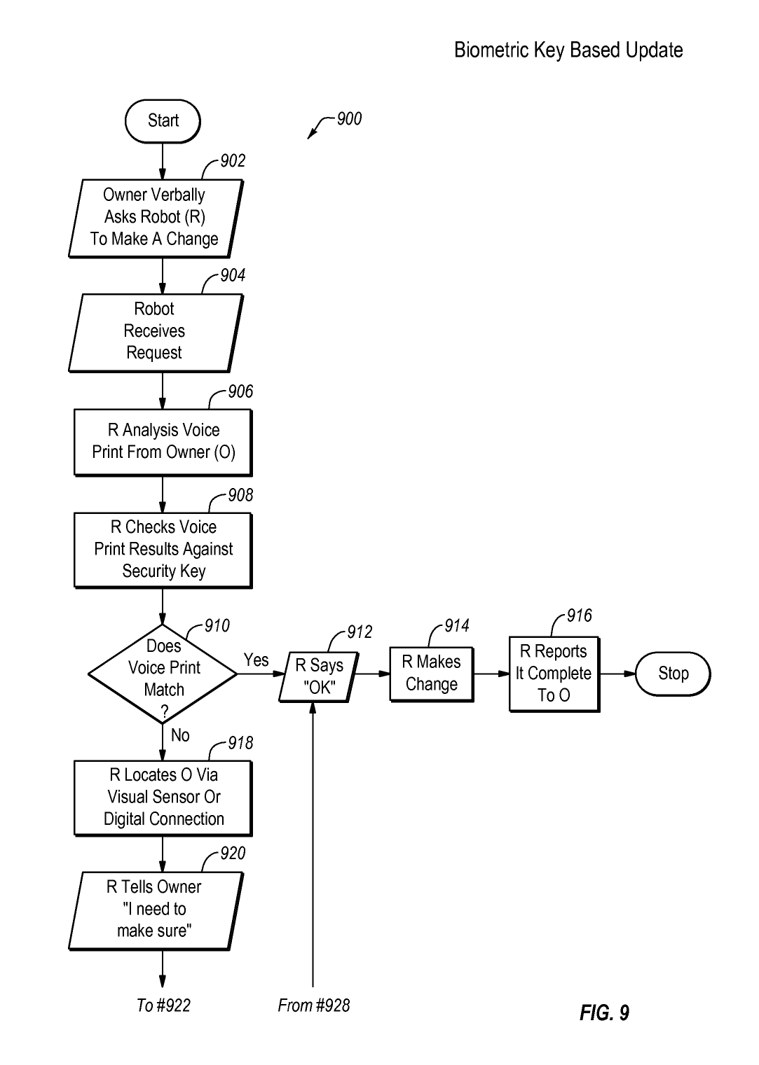

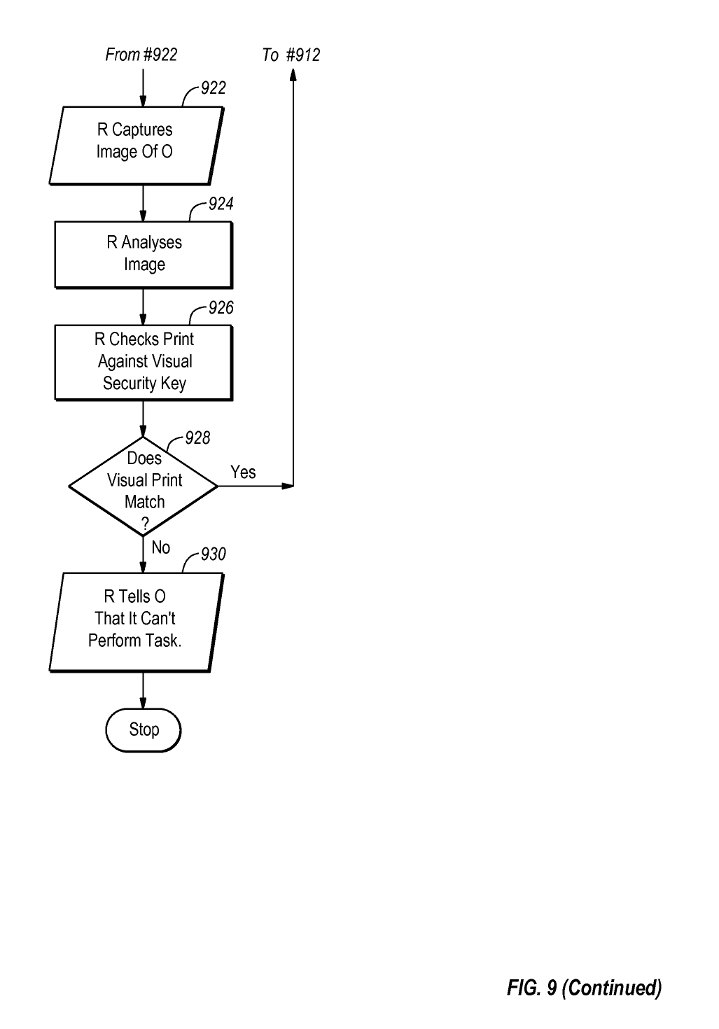

FIG. 9 illustrates a biometric key based robot update process 900. As illustrated at 902, an owner can verbally ask a robot to make a change (e.g., to applications, software, purchase settings, behavior, personality, etc.). At 904, the robot can receive the request. At 906, the robot can analyze the voice print from the owner, and at 908, the robot can check the voice print results against security keys (e.g., the security keys exchanged during a “hello protocol” process as illustrated in FIG. 3). At 910, the robot can determine whether the voice print matches. If yes, then at 912, the robot can say, e.g., “okay,” at 914, can make the change, and at 916, can report the change complete to the owner. In some embodiments, if the voice print does not match, the robot can obtain another voice print (e.g., by asking “could you repeat that?”) a number of times. If the one or more voice prints do not match, then at 918, the robot can locate the owner via a visual sensor (e.g., camera) or a digital connection (e.g., can locate a WiFi signal, Bluetooth signal or other digital identifier known to be associated with the owner). At 920, the robot can announce, e.g., “I need to make sure,” and at 922, can capture a visual picture of the owner. At 924, the owner can analyze the visual picture (e.g., by analyzing the face and creating a face print), and at 926, the robot can check the print against a visual security key. At 928, the robot can determine if the visual print matches one or more security keys. If yes, then the robot can say, e.g., “okay,” can make the change, and can report it complete to the owner, as described above. If no, then in some embodiments, the robot may say, e.g., “I'm sorry, I didn't quite get it,” and capture a new visual. After one or more failed attempts, at 930, the robot can tell the owner that it cannot perform the task. In some embodiments, the robot may suggest alternative methods (e.g., connecting the robot to the local client).

Certain embodiments are now described in the context of methods that are performed at one or more computer systems, such as cloud service 120, local client 130, and/or robot 150. These embodiments are described in the context of the modules/components, systems, and processes described in connection with FIGS. 1-9.

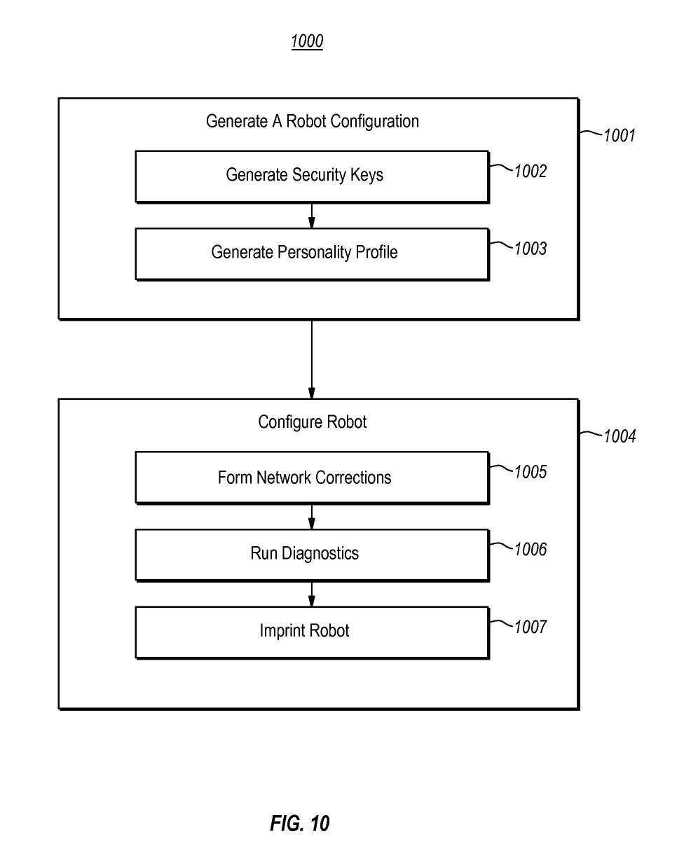

FIG. 10 illustrates a flow chart of an example method 1000 for configuring a robot computing device. As depicted, method 1000 comprises an act 1001 of generating a robot configuration. Act 1001 can include, for example, generating a robot configuration for a robot computing device. For example, using build application 126b, the local client 130 and/or the cloud service 120 can form a robot configuration for a robot 150. The robot configuration can include, for example, personality data 122a/132a, family rank data 122b/132b, and/or security keys 122c/132c.

Accordingly, act 1001 can include an act 1002 of generating security keys. Act 1002 can include generating one or more security keys, the one or more security keys including at least one owner key identifying an owner associated with the robot computing device. For example, the local client 130 and/or the cloud service 120 can generate an owner key as part of security keys 122c/132c.

Act 1001 can also include an act 1003 of generating a personality profile. Act 1003 can include generating a robot personality profile for the robot computing device, the robot personality profile including at least one robot personality setting for imprinting on the robot computing device. For example, the local client 130 and/or the cloud service 120 can generate personality data 122a/132a. Personality data may be generated, for example, in connection with user interfaces such as the personality profile tool user interface 402 of FIG. 4.

Method 1000 also comprises an act 1004 of configuring the robot. Act 1004 can include configuring the robot computing device according to the generated robot configuration. For example, the local client 130 and/or the cloud service 120 can configure the robot 150 using one or more portions of the described in connection with the build procedure described in connection with FIG. 2 and/or the “hello protocol” described in connection with FIG. 3.

Act 1004 can include, for example, an act 1005 of forming network connections. Act 1005 can include forming one or more network connections with the robot computing device. For example, the local client 130 and/or the cloud service 120 can form one or more network connection with robot 150. For example the local client 130 may connect to the robot 150 using WiFi, Bluetooth, etc.

Act 1004 can also include an act 1006 of running diagnostics. Act 1006 can include running diagnostics on the robot computing device to verify proper operation of the robot computer device. For example, local client 130 may run one or more verification steps, as described in connection with the “hello protocol” of FIG. 3

Act 1004 can also include an act 1007 of imprinting the robot. Act 1007 can include imprinting the robot computing device with the robot configuration, including sending the one or more security keys and the robot personality profile to the robot computing device over the one or more network connections. For example, the local client can send one or more of personality data 122a/132a, family rank data 122b/132b, and/or security keys 122c/132c to robot 150 (e.g., where it is imprinted on the robot as personality data 152a, family rank data 152b and/or security keys 152c).

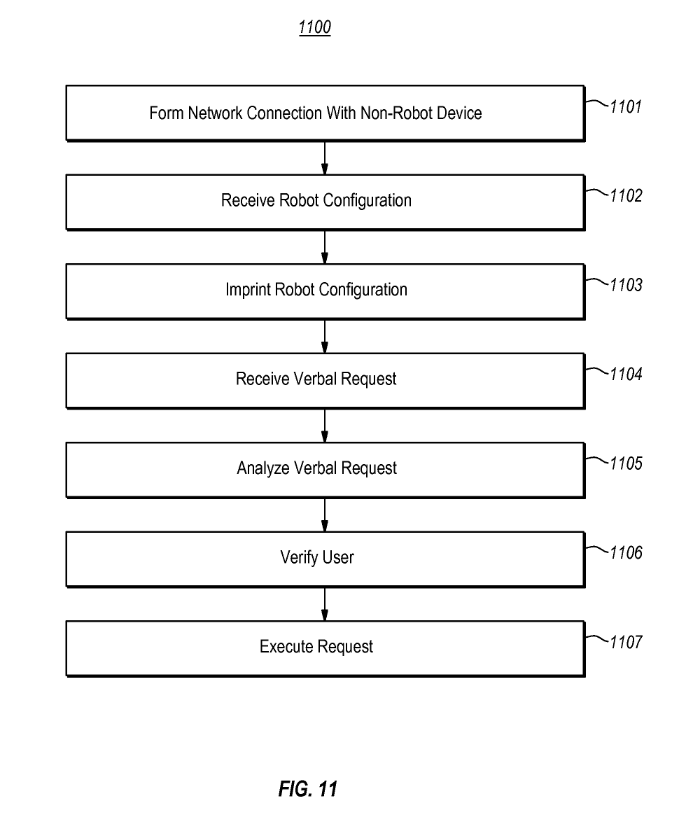

FIG. 11 illustrates a flow chart of another example method 1100 for configuring a robot computing device. As depicted, method 1100 comprises an act of 1101 of forming a network connection with a non-robot device. Act 1101 can include forming one or more network connections with a non-robot computing device. For example, local client 130 may form one or more network connection with robot 150 using WiFi, Bluetooth, etc.

Method 1100 also comprises an act of 1102 of receiving a robot configuration. Act 1102 can include receiving, over the one or more network connections, a robot configuration including one or more biometric owner keys identifying an owner of the robot computing device by one or more of owner visual appearance or owner voice, and a robot personality profile including at least one robot personality setting for imprinting on the robot computing device. For example, the robot 150 can receive from local client 130 security keys 132c (including biometric owner key(s) that can be used to identify a human by his or her visual appearance and/or voice) and personality data 132a (e.g., such as personality data configured using the personality profile tool user interface 402 of FIG. 4 or other user interfaces).

Method 1100 also comprises an act of 1103 of imprinting the robot configuration. Act 1103 can include imprinting the robot configuration on the robot computing device. For example, robot 150 can imprint the security keys 132c and personality data 132a upon itself, such by storing them locally (as depicted at personality data 152a and security keys 152c).

Method 1100 also comprises an act of 1104 of receiving a verbal request. Act 1104 can include receiving a verbal request from a user to alter the robot configuration. For example, a human user may make a verbal request of robot 150, which can be detected as an audio signal by one or more microphones at robot 150. In some embodiments, robot 150 may also capture an image of the human user using a camera.

Method 1100 also comprises an act of 1105 of analyzing the verbal request. Act 1105 can include analyzing the verbal request by comparing the request to the at least one biometric owner key. For example, as depicted in FIG. 9, robot 150 can verify the user through voice print match (e.g., by comparing the audio signal of the verbal request to an owner voice key) and/or visual match (e.g., by comparing the an image to an owner visual appearance key).

Method 1100 also comprises an act of 1106 of verifying a user. Act 1106 can include verifying that the user is authorized to modify the robot computing device. For example, if the voice print match and/or the visual match pass, the user may be verified.

Method 1100 also comprises an act of 1107 executing the request. Act 1107 can include executing the request. For example, if the user is verified, robot 150 may perform the configuration change, as requested.

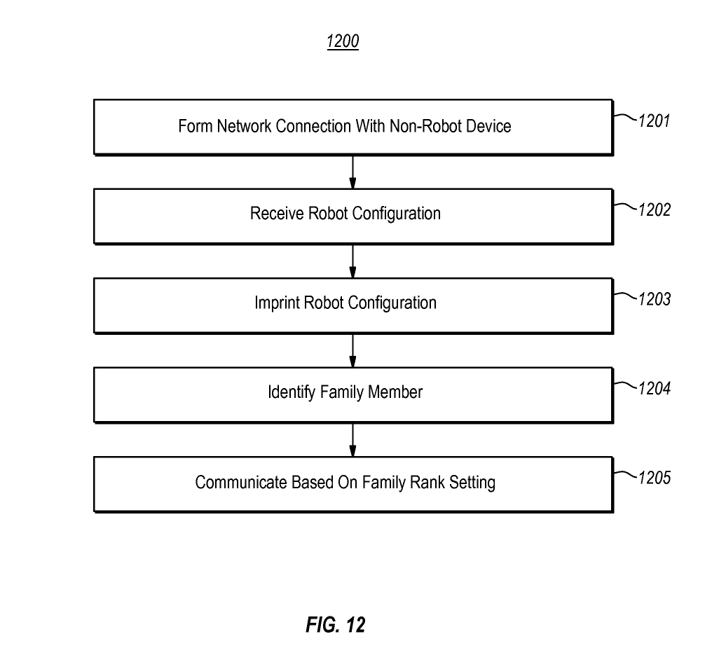

FIG. 12 illustrates a flow chart of an example method 1200 for relationally communicating with another computing device or robot computing device. As depicted method 1200 comprises an act 1201 of forming a network connection with a non-robot device. Act 1201 can include forming one or more network connections with a non-robot computing device. For example, local client 130 may form one or more network connection with robot 150 using WiFi, Bluetooth, etc.

Method 1200 also comprises an act of 1202 of receiving a robot configuration. Act 1202 can include receiving, over the one or more network connections, a robot configuration. The robot configuration can include one or more security keys including at least one robot key identifying the robot computing device. For example, robot 150 can receive from local client 130 security keys 122c, including a key identifying robot 150.

The robot configuration can also include a robot personality profile including at least one robot personality setting for imprinting on the robot computing device. For example, robot 150 can receive from local client 130, personality data 132a (e.g., such as personality data configured using the personality profile tool user interface 402 of FIG. 4 or other user interfaces).

The robot configuration can also include a robot family rank setting associating the robot computing device with a device family including at least one additional computing device or robot computing device, and enabling the robot computing device to determine a hierarchical position within the device family. For example, robot 150 can receive from local client 130, family rank data 132b. As depicted in FIG. 6, the family rank data 132b can specify a hierarchical position of robot 150 within the device family.

Method 1200 also comprises an act of 1203 of imprinting the robot configuration. Act 1203 can include imprinting the robot configuration on the robot computing device. For example, robot 150 can imprint the personality data 132a, the family rank data 132b, and the security keys 132c upon itself, such by storing them locally (as depicted at personality data 152a, family rank data 152b, and security keys 152c).

Method 1200 also comprises an act of 1204 of identifying a family member. Act 1204 can include identifying the at least one additional computing device or robot computing device as a member of the device family. For example, robot 150 may encounter another device in the family, such as over a wireless network connection.

Method 1200 also comprises an act of 1205 of communicating based on family rank setting. Act 1205 can include, based on the family rank setting, communicating with the at least one additional computing device or robot computing device. For example, robot 150 can interact with the other device according to their relative positions in the device family hierarchy, such as according to the family rank rules engine 700 of FIG. 7.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for configuring a robot computing device, implemented at a computer system that includes one or more processors, the method comprising:
generating a robot configuration for the robot computing device, including:
generating one or more security keys, the one or more security keys including at least one owner key identifying an owner associated with the robot computing device;
generating a robot personality profile for the robot computing device, the robot personality profile including at least one robot personality setting for imprinting on the robot computing device; and
configuring the robot computing device according to the generated robot configuration, including:
forming one or more network connections with the robot computing device;
running diagnostics on the robot computing device to verify proper operation of the robot computer device; and
imprinting the robot computing device with the robot configuration, including sending the one or more security keys and the robot personality profile to the robot computing device over the one or more network connections.

2. The method of claim 1, further comprising, receiving a user selection of a name of the robot computing device, and imprinting the name on the robot computing device.

3. The method of claim 1, further comprising, receiving a user selection of a visual appearance of the robot computing device and a user selection of a voice of the robot computing device, and assigning the visual appearance and the voice to the robot computing device.

4. The method of claim 1, wherein the at least one owner key includes an owner visual appearance key and/or an owner voice key.

5. The method of claim 1, wherein the one or more security keys includes at least one robot key identifying the robot computing device.

6. The method of claim 5, wherein the at least one robot key includes a robot visual appearance key and/or a robot voice key.

7. The method of claim 1, wherein the robot configuration further includes a robot family rank setting, the robot family rank setting enabling the robot computing device to determine a hierarchical relationship relative to at least one additional computing device or robot computing device.

8. The method of claim 7, wherein the hierarchical relationship defines an additional robot computing device as at least one of a peer, older sibling, younger sibling, or pet of the robot computing device.

9. The method of claim 7, wherein the one or more security keys includes at least one robot key, the at least one robot key enabling the at least one additional computer device or robot computing device to identify the robot computing device.

10. The method of claim 1, further comprising downloading one or more robot applications from a remote service and adding the one or more robot applications to the robot configuration.

11. The method of claim 1, further comprising, based on the robot personality profile, generating a plurality of robot behaviors and adding the plurality of robot behaviors to the robot configuration.

12. The method of claim 11, wherein the robot configuration further includes a behavior manager and a conflict manager configured to manage the plurality of robot behaviors relative to each other and relative to other actions of the robot computing device.

13. A method, implemented at a robot computing device, for configuring the robot computing device, the method performed in a computing environment by executing computer executable instructions upon one or more computer processors, the method comprising:
forming one or more network connections with a non-robot computing device;
receiving, over the one or more network connections, a robot configuration including one or more biometric owner keys identifying an owner of the robot computing device by one or more of owner visual appearance or owner voice, and a robot personality profile including at least one robot personality setting for imprinting on the robot computing device;
imprinting the robot configuration on the robot computing device;
receiving a verbal request from a user to alter the robot configuration;
analyzing the verbal request by comparing the request to the at least one biometric owner key;
verifying that the user is authorized to modify the robot computing device; and
executing the request.

14. The method of claim 13, wherein analyzing the verbal request by comparing the request to the at least one biometric owner key includes comparing an audio signal of the verbal request to an owner voice key, and if unable to verify that the user is authorized based on the audio signal, locating the owner, capturing an image of the owner, and comparing the image of the owner with an owner visual appearance key.

15. A method, implemented at a robot computing device, for relationally communicating with another computing device or robot computing device, the method performed in a computing environment by executing computer executable instructions upon one or more computer processors, the method comprising:
forming one or more network connections with a non-robot computing device;
receiving, over the one or more network connections, a robot configuration including:
one or more security keys including at least one robot key identifying the robot computing device;
a robot personality profile including at least one robot personality setting for imprinting on the robot computing device; and
a robot family rank setting associating the robot computing device with a device family including at least one additional computing device or robot computing device, and enabling the robot computing device to determine a hierarchical position within the device family;
imprinting the robot configuration on the robot computing device;
identifying the at least one additional computing device or robot computing device as a member of the device family; and
based on the family rank setting, communicating with the at least one additional computing device or robot computing device.

16. The method of claim 15, wherein the at least one robot key includes a robot visual appearance key and/or a robot voice key.

17. The method of claim 15, wherein identifying the at least one additional computing device or robot computing device includes recognizing an additional robot computing device based on an additional robot voice key or an additional robot visual appearance key.

18. The method of claim 15, further comprising being identified by the at least one additional computing device or robot computing device as a member of the device family based on the at least one robot key.

19. The method of claim 15, wherein the hierarchical position within the device family is at least one of a peer, older sibling, younger sibling, or pet of the robot computing device.

20. The method of claim 15, wherein communicating with the at least one additional computing device or robot computing device includes sending instructions to the at least one additional computing device or robot computing device if the robot computing device has a higher rank than the at least one additional computing device or robot computing device, or receiving instructions from the at least one additional computing device or robot computing device if the robot computing device has a lower rank than the at least one additional computer device or robot computing device.
